(19) United States
(12) Patent Application Publication
(10) Pub. No.: US 2009/0085702 A1
(43) Pub. Date: Apr. 2, 2009

(54) Connector and Power Transformer Structure Comprising the Same

(75) Inventors: Jianhong Zeng, Shanghai (CN); Bin Wang, Shanghai (CN); Hongyang Wu, Shanghai (CN); Jianping Ying, Shanghai (CN)

Correspondence Address: GROSSMAN, TUCKER, PERREAULT & PFLEGER, PLLC, 55 SOUTH COMMERICAL STREET, MANCHESTER, NH, 03101, US

(73) Assignee: DELTA ELECTRONICS, INC., Taoyuan Hsien (TW)

(21) Appl. No.: 12/029,081

(22) Filed: Feb. 11, 2008

(30) Foreign Application Priority Data
Sep. 29, 2007 (TW) 096136595

(51) Int. Cl. H01F 27/40

(52) U.S. Cl. 336/107

(57) ABSTRACT

A connector and a power transformer structure comprising the same are provided. The power transformer structure comprises a connector and an integrated transformer. The connector comprises a plurality of connection units, and the integrated transformer comprises a plurality of transformation units. The transformation units are sequentially stacked and electronically connected to the corresponding connection units in contact connection to reduce the current conduction consumption and contact resistance.

This application claims the benefit of priority based on Taiwan Patent Application No. 096136595 filed on Sep. 29, 2007 of which the contents are incorporated herein by reference in its entirety

### CROSS-REFERENCES TO RELATED APPLICATIONS

Not applicable.

### BACKGROUND OF THE INVENTION

1. Field of the Invention

The present invention relates to a connector and a power transformer structure comprising the same. More particularly, the present invention relates to a connector and a power transformer structure comprising the same that may decrease current conduction loss and contact resistance.

2. Descriptions of the Related Art

With rapid development of semiconductor technologies, a variety of chips are requiring a lower voltage level but a higher supply current. Meanwhile, power supply are becoming increasingly higher efficiency and high power density. Under such conditions, in addition to the optimized design of circuit topologies, component and circuit parameters, design of other aspects such as the printed circuit board (PCB) layout, wiring, mechanism design and thermal design also plays a more and more important role in optimizing a power supply circuit.

Referring to FIG. 1, that illustrates a schematic diagram of a conventional transformer 1. The transformer 1 comprises a plurality of transformation units 10 and copper posts 11a and 11b. The copper posts 11a and 11b are respectively connected with the current output ends 100 and 101 of each transformation unit 10 by welding, so that the output current from each transformation unit 10 is transmitted out via the copper posts 11a and 11b.

Referring to FIG. 2, that illustrates a schematic partial diagram of a power supply device comprising a transformer 1 disposed on a power supply motherboard 2. The power supply motherboard 2 comprises copper foils 2a and 2b respectively connected with the copper posts 11a and 11b by welding, so that the output current from the transformer 1 is transmitted out via the copper posts 11a and 11b. Further Referring to FIG. 3 corresponding to FIG. 2, FIG. 3 is a schematic diagram of connector between a power supply motherboard and a load. The power supply motherboard 2 has a plurality of connection units 3, which are connected with the copper foils 2a and 2b respectively by welding. Additionally, connector motherboard 4 has a plurality of connection terminals 40, which are welded to one end of the conducting boards 4a and 4b respectively, while a load 5 is connected to the other end of the conducting boards 4a and 4b of the connector motherboard 4 via connecting lines 5a and 5b. In this way, the output current from the transformer 1 is transmitted to the load 5 sequentially through the connection units 3, connection terminals 40, the conducting boards 4a, 4b of the connector motherboard 4, and the connecting lines 5a, 5b.

However, to cater for the continuous increase in power density of power supplies, volume of the connecting structure between the transformer 1 and the load 5 has to be reduced accordingly, which requires a corresponding reduction of the number of parallel output connections of the transformer. Unfortunately, in the connecting structure described above, the conducting connections downstream of the connection between the transformer 1 and the power supply motherboard 2 are distributed in a plane, which leads to underutilization of the overall space of the transformer 1 in the height dimension. Furthermore, a considerable number of welding points exist in the connecting structure described above, such as the welding joints between the copper post 11a, 11b and the current output terminals 100, 101 of each transformation unit 10, and also the welding joints between the copper posts 11a, 11b and the copper foils 2a, 2b. Such welding points may cause increasing contact resistance and energy loss, with a consequence that the load 5 can not effectively receive the power energy supplied by the conventional transformer 1.

In summary, how to effectively utilize the overall space of a transformer in the height dimension and decrease the contact resistance and energy loss between the transformer and the load is still an objective for the industry to endeavor.

### SUMMARY OF THE INVENTION

One objective of the present invention is to provide a power transformer structure comprising a connector and an integrated transformer. The connector comprises a plurality of connection units, and the integrated transformer comprises a plurality of transformation units. These transformation units are sequentially stacked and electronically connected to the corresponding connection units in contact connection for outputting power to a load via the connector.

Another objective of the present invention is to provide a connector for use in a power transformer structure comprising an integrated transformer. The integrated transformer comprises a plurality of transformation units which is sequentially stacked. The connector comprises a plurality of connection units and at least one conductor. The connection units are electronically connected to the corresponding transformation units in contact connection so that the integrated transformer outputs power to a load via the connector. The at least one conductor is electronically connected to the connection units.

According to the present invention, the integrated transformer and the connector are electrically connected in contact connection instead of in welding connection as used in the conventional, thereby to decrease contact resistance therebetween. Moreover, the connector and the transformation units are vertically connected in parallel, in order to make full use of the overall space of the transformer structure in the height dimension and effectively decrease the conduction loss. As a result, disadvantages of the conventional can be overcome effectively.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic diagram of a conventional transformer;

FIG. 2 is a schematic diagram of a conventional transformer disposed on a power supply motherboard;

FIG. 3 is a schematic diagram of connector between the power supply board and a load corresponding to FIG. 2;

FIG. 4 is a schematic diagram of a power transformer structure and corresponding connector in accordance with a first embodiment of the present invention;

FIG. 5A is a top diagram of a secondary PCB circuit in the first embodiment of the present invention;

FIG. 5B is a bottom diagram of the secondary PCB circuit in the first embodiment of the present invention;

FIG. 6 is a schematic diagram of a power transformer structure and corresponding connector in accordance with a second embodiment of the present invention;

FIG. 7 is a schematic diagram of a power transformer structure and corresponding connector in accordance with a third embodiment of the present invention; and

FIG. 8 is a schematic diagram of connection between a power transformer structure and a load.

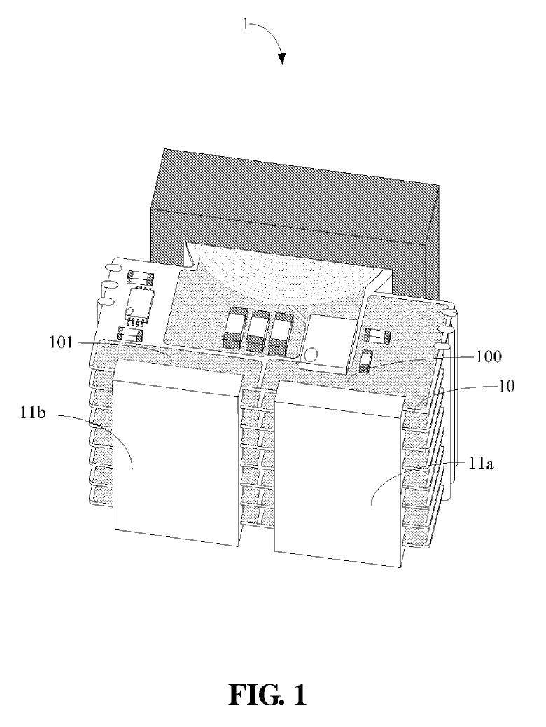

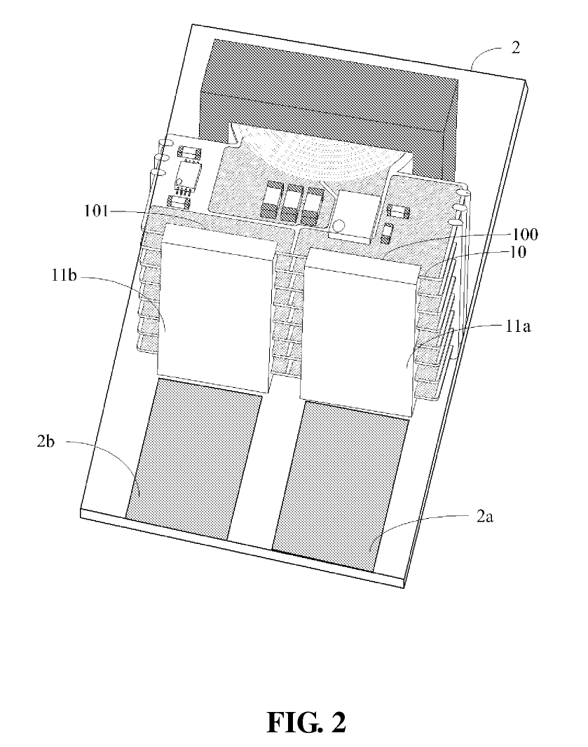

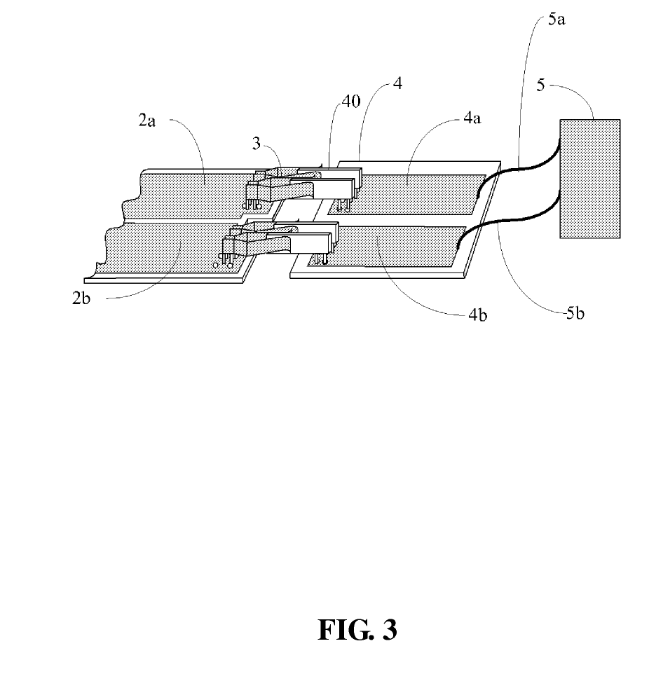

### DESCRIPTION OF THE PREFERRED EMBODIMENT

The present invention relates to a power transformer structure that may effectively utilize the overall space thereof in the height dimension and decrease conduction loss. The following embodiments will be described to explain the present invention. However, these embodiments are not intended to limit that the present invention can only be embodied in any specific context, applications or with particular methods described in these embodiments. Therefore, description of the embodiments is only intended to illustrate the present invention, rather than to limit the present invention. It should be noted that, in the following embodiments and attached drawings, elements not directly relating to the present invention are omitted from the diagrams, and the dimensional relationships among various elements are deliberately exaggerated for ease of understanding.

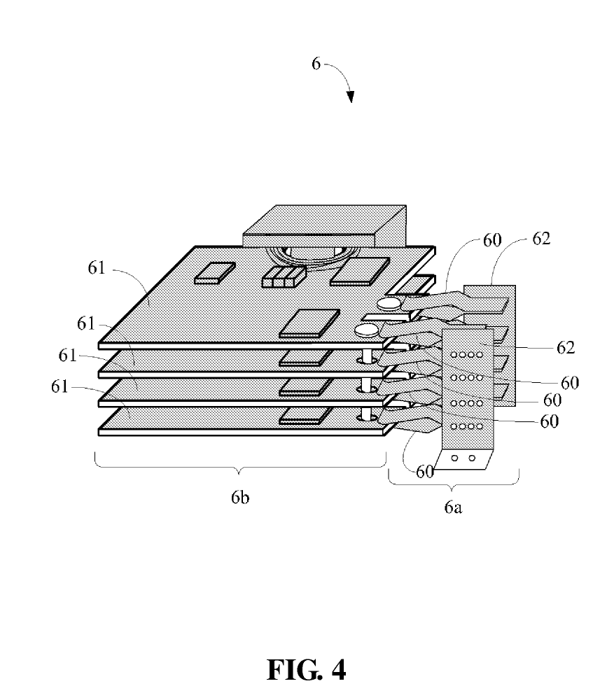

A power transformer structure 6 of a first embodiment of the present invention is illustrated in FIG. 4. The power transformer structure 6 may be applied in a high frequency power converter, which is well-known by people skilled in the art and redundant description is omitted hereinafter. The power transformer structure 6 comprises a connector 6a and an integrated transformer 6b electrically connected with each other in contact connection. More particularly, the connector 6a comprises a plurality of connection units 60 and a conductor 62, while the integrated transformer 6a comprises a plurality of transformation units 61. In the embodiment, the conductor 62 is a conductor bus bar. The transformation units 61 are sequentially stacked with each other and electrically connected to corresponding connection units 60 in contact connection. The conductor 62 is configured to electrically connect to the connection units 60, so that current from the power transformer structure 6 can be transferred through the connection units 60 and the conductor 62 to a load (not shown) electrically connected with the conductor 62. The transformation units 61 are electrically connected in parallel together.

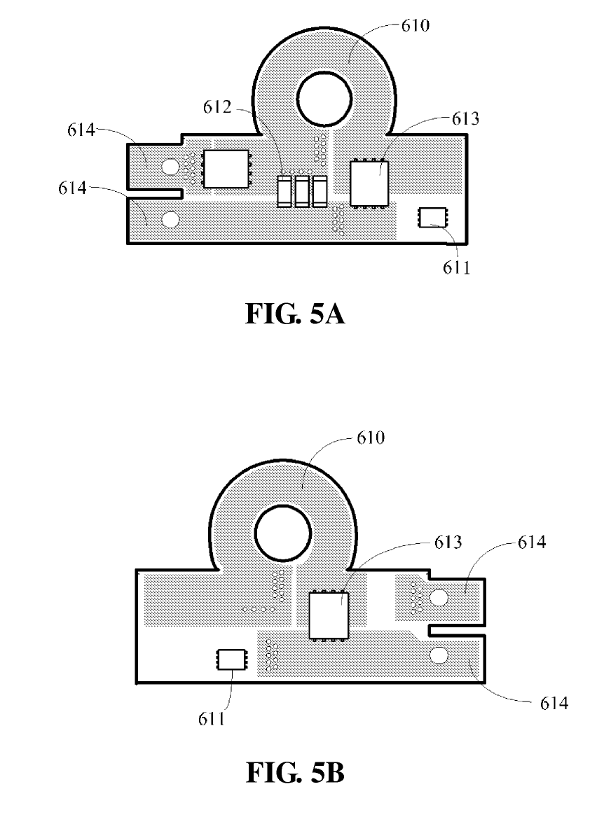

In this embodiment, each of the transformation units 61 is a flat transformation unit comprising a primary winding (not shown) and a secondary printed circuit board (PCB) circuit (described in detail hereafter), where the primary winding is implemented with the conventional technologies and will not be described herein. Please referring to FIG. 5A and FIG. 5B, a vertical view diagram and an upward view diagram of the secondary PCB circuit are illustrated respectively therein. The secondary PCB circuit comprises a secondary winding 610, a rectifier 611, a capacitor 612, a driving circuit 613 and a goldfinger structure 614, where the rectifier 611 and the capacitor 612 are conventional electronic elements and will not be described herein. The driving circuit 613 functions as a switch for the power transformer structure 6, and the goldfinger structure 614 is configured to electrically connect the transformation units 61 with the connection units 60 in contact connection. Specifically, the goldfinger structure 614 of any of the transformation units 61 is electrically connected with corresponding connection units 60 in contact connection, so that any of the transformation units 61 may supply a current to the connection units 60 and further to the load therefrom via its own goldfinger structure 614.

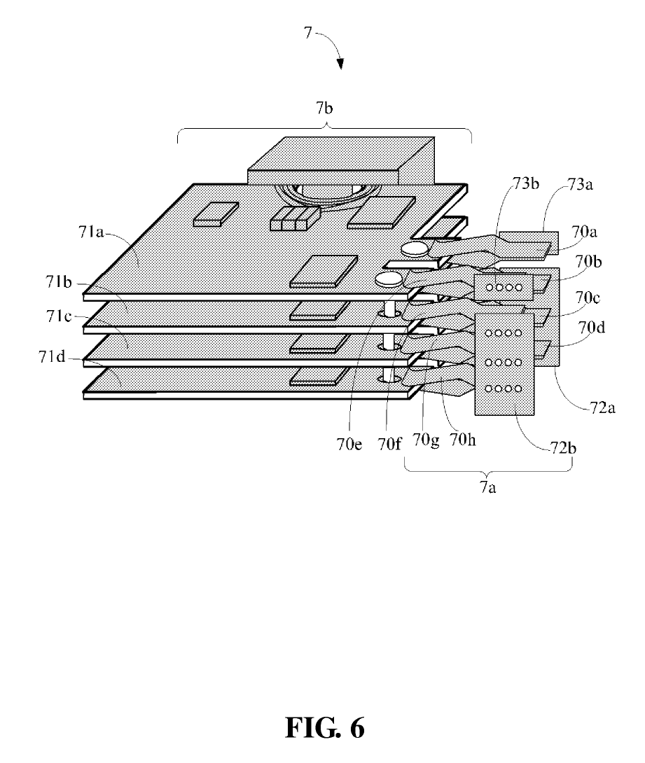

Referring to FIG. 6, where illustrates a power transformer structure 7 of a second embodiment of the present invention. The power transformer structure 7 comprises a connector 7a and an integrated transformer 7b. The connector 7a further comprises a plurality of connection units 70a, 70b, 70c, 70d, 70e, 70f, 70g, 70h and a plurality of conductors 72a, 72b, 73a, 73b. The integrated transformer 7b comprises a plurality of transformation units 71a, 71b, 71c, 71d, where each of the conductors are electrically connected with at least one of the connection units. In this embodiment, the conductor 73a is connected to the connection unit 70a, the conductor 73b is connected to the connection unit 70e, the conductor 72a is connected to the connection units 70b, 70c, 70d, and the conductor 72b is connected to the connection units 70f, 70g and 70h. The transformation unit 71a is electrically connected to the conductors 73a and 73b via the connection units 70a and 70e respectively, and similarly, the transformation units 71b, 71c and 71d are electrically connected to the conductors 72a and 72b respectively. As a result, the transformation units 71b, 71c and 71d connected to the conductors 72a and 72b are electrically connected with each other in parallel.

With above configurations, welding connections as used in the conventional transformer are replaced by the electrically contacting connections in the power transformer structure of the present invention. That decreases the contact resistance. Moreover, by use of parallel connections, the present invention effectively uses the overall space of the transformer structure in the height dimension and decreases the conduction loss by parallel connection.

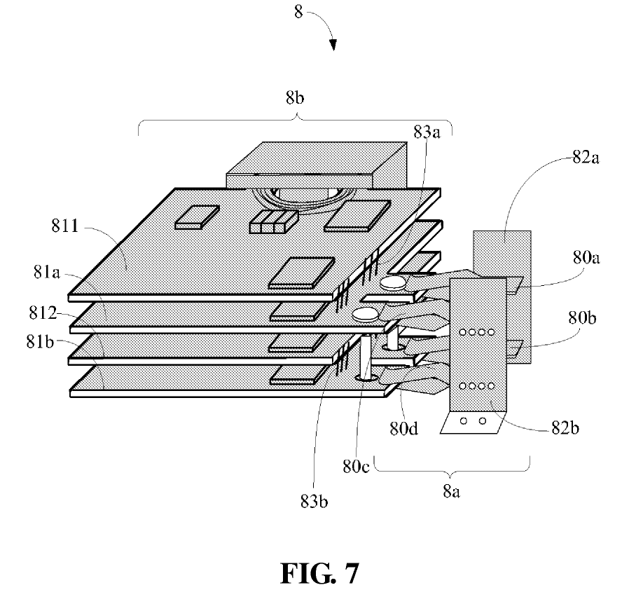

A power transformer structure 8 of a third embodiment of the present invention is illustrated in FIG. 7. The power transformer structure 8 comprises a connector 8a and an integrated transformer 8b. The connector 8a comprises a plurality of connection units 80a, 80b, 80c, 80d, conductors 82a, 82b, and internal conductors 83a, 83b. The integrated transformer 8b comprises a plurality of transformation units 811, 81a, 812, 81b. The functions of the connection units 80a, 80b, 80c, 80d, the transformation units 811, 81a, 812, 81b, and the conductors 82a, 82b are the same as the ones described in the previous embodiment, and will not be described herein.

The most significant difference from the previous embodiment lies in that this embodiment comprises internal conductors 83a, 83b. Taking the internal conductor 83a as an example, it is configured to have the transformation units 811 and 81a connected with each other in parallel, so that the transformation units 811 and 81a connected in parallel may be electrically connected to the connection units 80a and 80c in contact connection. Specifically, in this embodiment, since the two transformation units 811 and 81a are connected together by the internal conductor 83a, more current may be output to the connection units 80a, 80c as compared to the single transformation unit. In this embodiment, the internal conductors 83a, 83b are made of copper. However, the number of transformation units connected in parallel by the internal conductors 83a, 83b and the material of the internal conductors 83a, 83b are just for purpose of illustration, rather than to limit the scope of the present invention.

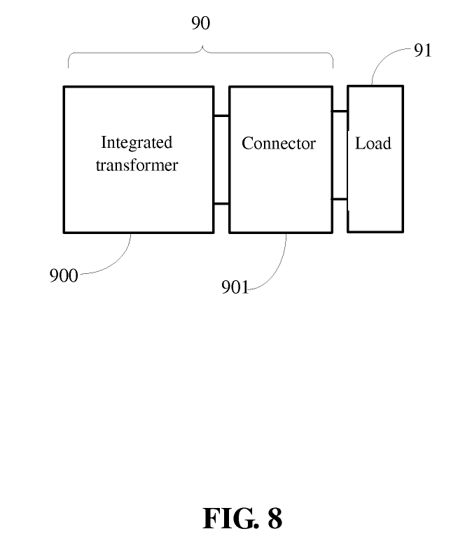

Referring to FIG. 8, FIG. 8 is a schematic diagram of connection between a power transformer structure 90 and a load 91. The power transformer structure 90 comprises an integrated transformer 900 and a connector 901, wherein the integrated transformer 900 is connected to the load 91 via the connector 901 to supply power to the load 91. It should be noted that, the connection structure illustrated in FIG. 8 may also be applied in other embodiments described above.

In practical industrial applications, the connector is typically an indispensable separate element. The integrated transformer is installed in a fixed housing and has the output end connected with the connector via an opening of the housing. The connection units of the connector and conductors are installed in an insulation (plastic) housing of the connector. The connector is connected with the output terminals of the integrated transformer via the connection units. The connection units and conductors of the connector eliminate the copper posts (11a, 11b) and the copper foils (2a, 2b) existing in the conventional transformer structures, when keep functions (busbar) of the original structure with a lower energy loss.

As described above, in the present invention, the transformation units and the connection units are electrically connected in contact connection to decrease the contact resistance. Moreover, the connection units and the transformation units are vertically connected in parallel to effectively use the overall space of the transformer structure in the height dimension and to effectively decrease the conduction loss. As a result, disadvantages of the conventional techniques can be overcome effectively.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A power transformer structure, comprising:
a connector comprising a plurality of connection units; and
an integrated transformer comprising a plurality of transformation units, the transformation units being sequentially stacked and electronically connected to the corresponding connection units in contact connection for outputting power to a load via the connector.

2. The power transformer structure of claim 1, wherein the connector further comprises a conductor being electronically connected to the connection units.

3. The power transformer structure of claim 1, wherein the transformation units are electronically connected in parallel connection.

4. The power transformer structure of claim 1, wherein the connector further comprises a plurality of conductors, and any of the conductors is electronically connected to at least one of the connection units.

5. The power transformer structure of claim 4, wherein the transformation units are electronically connected to the conductors via the connection units, and the transformation units connected to any of the conductors are electronically connected in parallel connection.

6. The power transformer structure of claim 1, wherein any of the transformation units is a flat transformation unit comprising a primary winding and a secondary printed circuit board (PCB) circuit, and the secondary PCB circuit comprises a secondary winding, a rectifier, a capacitor, and a drive circuit.

7. The power transformer structure of claim 1, wherein the integrated transformer further comprises an internal conductor being configured to connect a plurality of the transformation units in parallel connection, and the transformation units are electronically connected to one of the connection units in contact connection.

8. The power transformer structure of claim 7, wherein the internal conductor is made of copper.

9. The power transformer structure of claim 7, wherein the connector further comprises a conductor being configured to electronically connect to the connection units.

10. The power transformer structure of claim 7, wherein the connector further comprises a plurality of conductors, and any of the conductors is electronically connected to at least one of the connection units.

11. The power transformer structure of claim 1, wherein any of the transformation units comprises a goldfinger structure being configured to make the transformation units electronically connected to the connection units in contact connection via the goldfinger structure.

12. A connector for use in a power transformer structure comprising an integrated transformer, the integrated transformer comprising a plurality of transformation units being sequentially stacked, the connector comprising:
a plurality of connection units being electronically connected to the corresponding transformation units in contact connection so that the integrated transformer outputs power to a load via the connector; and
at least one conductor being electronically connected to the connection units.

13. The connector of claim 12 comprising a plurality of conductors, in which any of the conductors is electronically connected to at least one of the connection units.

14. The connector of claim 13, wherein the transformation units are electronically connected to the conductors via the connection units, and the transformation units connected to any of the conductors are electronically connected to each other in parallel connection.
